(19) United States
(12) Patent Application Publication
(10) Pub. No.: US 2019/0255754 A1
(43) Pub. Date: Aug. 22, 2019

(54) MEASURING DEVICE AND METHOD FOR MEASURING TWO OR THREE-DIMENSIONAL FILM TOPOGRAPHY AND METHOD FOR RECOGNISING IN-LINE PATTERNS IN TWO OR THREE-DIMENSIONAL FILM TOPOGRAPHY

(71) Applicant: Reifenhauser GmbH & Co. KG Maschienenfabrik, Troisdorf (DE)

(72) Inventors: Christoph Lettowsky, Aachen (DE); Paul Walach, Troisdorf (DE)

(21) Appl. No.: 16/343,231

(22) PCT Filed: Aug. 1, 2017
(86) PCT No.: PCT/DE2017/000230

§ 371 Date: Apr. 18, 2019

(30) Foreign Application Priority Data
Oct. 18, 2016 (DE) 10 2016 012 426.1
Jul. 19, 2017 (DE) 10 2017 006 818.6

(51) Int. Cl. B29C 48/92; G01B 11/25; B29C 48/00; B29C 48/08; B29C 48/10

(52) U.S. Cl. CPC B29C 48/92; G01B 11/254; B29C 48/0018; B29C 48/08; B29C 2948/92942; B29C 2948/92285; B29C 2948/92447; B29C 2948/92152; B29C 2948/92647; B29C 48/10

(57) ABSTRACT

The invention relates to the detection and use of film topography (23) of a film web (13, 40, 51) produced in blow film or casting film methods for improving the quality of the film web (13, 40, 51). In particular, film topography (23) can be quantitatively detected using said the invention. In another aspect of the invention, the film topography (23) is analysed using a pattern recognition algorithm and is optionally allocated an error image (50). This information is used in order to improve the quality of the film web (13, 40, 51) by controlling action recommendations dependent on the error image and to quantitatively detect the flatness of a film web (13, 40, 51). The invention also relates to an influencing element (30) for influencing the properties of a film web (13, 40, 51) in the position where the film topography (23) is determined.

The invention relates to a measuring device for measuring a two- or three-dimensional film topography, a plant for producing a film web, a method for inline pattern recognition of defect images in a two- or three-dimensional film topography, a method of controlling the process of producing a film web for preventing error images, a method for regulating the production process of a film to prevent error images, a process for inline determination of a flatness position, a plant for producing a film web and a method for inline determining a first error, in particular a flatness position error.

In the blown film extrusion is formed plastic melt provided by the extruder with help of a blow head through an annular gap to a film tube. The foil tube is then guided from the calibration basket and fold up together in the flat-laying part.

Due to process-related deviations in the film topography and/or different cooling and/or uneven local stresses so-called flatness position error arise.

These have, in particular, undesirable effects on the further processability of the films and on the windability of the films.

Flatness position deviations of films are made visible nowadays by cutting off about a 10 Meter-long model film piece, which is spread on the floor and is swept. A more qualified measurement method for a flatness position measurement of unwound film webs is not currently known in the state of the art.

For other web materials, in particular more rigid sheet materials such as steel, aluminum and paper webs, are known measuring systems for flatness position measurement on the market. These have not yet been used in the film industry. When using these systems major hurdles are expected, because the flatness position error of flexible film is superimposed by a variety of influences.

The optical sensors used for stiffer sheet materials for the determination of the flatness position project a line onto the material web, detects by an optical sensor the behaviour of this line in an ongoing trajectory and apply a method that makes a conclusion to the flatness position error from the detected behaviour of the, onto the trajectory, projected line.

A flatness position error causes some “restless” behaviour of the line. Due to the value of deviations of the measuring line from a set average it can be concluded to a quantitative value of the flatness position.

For steel, aluminum and paper webs this type of flatness measurement works well, because these materials have a high or at least comparatively high rigidity. Taken into account the completely different stability of a blown film, the flatness position measuring is for metal bands here not normally/strange in the art.

Due to the flexibility of a film web, the flatness position error of a web is superimposed in its appearance and thus also the measurement of this error (“restless line”) of other errors that have other causes, but affect the image of the web in the same way and thus the measuring. As an example are mentioned tension folds that arise by too high or low web tension in the film. These are folds that occur in the web direction.

Thus, a conclusion on the actual flatness position is due to a simple measurement, as it works on steel, aluminum and paper webs, is not possible.

WO 2007/107147 A1 discloses a method for detecting the flatness position deviation

of flexible, web-shaped, wound flat goods immediately when unrolling from a roll.

The DE 40 24 326 A1 discloses an apparatus and a method for reducing the

film slack and the tension profile, wherein the film web is heated, cooled and is stretched.

The invention is based on the object, to provide to the prior art an improvement

or an alternative.

According to a first aspect of the invention, the object is solved with a—by a measuring device for measuring a two- or three-dimensional film topography of a blown or cast film produced—film web with a radiation source, in particular a light source, a detector and a data processing and evaluation unit, wherein the radiation source and the detector have a different position, the radiation source projects a radiation pattern on a designated running section of the film web, wherein the radiation pattern is, in particular a line with in particular parallel light, wherein the detector is performed to detect the projected radiation pattern, in particular to detect the projected line, and the detector is focused on the projected radiation pattern, in particular the projected line, and wherein the data processing and evaluation unit has a programming, the programming for performing a triangulation method and/or a reflection method and/or a transmission method for determining the film topography.

Conceptually, the following is explained:

First of all, it should be noted that within the scope of the present patent application indefinite articles and numbers such as “one”, “two” etc. normally should be understood as “at least” information, so as “at least one . . . ”, “at least two . . . ” etc., unless they are based on the context expressed or it is obvious or technically imperative for the skilled person, that there can only be meant “exactly one . . . ”, “exactly two . . . ” and so on.

A “measuring device” means a measuring system, which consists of a light source and a detector, wherein the light source emits a light beam on a film web and

a reflected and/or transmitted light beam is detected by a detector, whereby the image captured by the detector for the determination and evaluation of the film topography is used. The measuring device can be used for single-layer or multi-layered film webs used, each, with one or more layers. Furthermore, a measuring device can have an additional adaptive illumination of the background. The measuring device can lighting the object, in particular the film web, with the lighting-through method and/or the incident light method and/or the streak method. The object can be illuminated before a light background and/or behind a dark background. At dark backgrounds it is distinguished between a dark background, a near dark background and a distant dark background. In particular, the measuring device uses a triangulation method and/or a reflection method and/or a transmission method.

A “film topography” describes the geometric shape of an outside of the film. Under the outside of the film web, both sides of the film web can be understood. Furthermore, the film topography is to understand macroscopic and not microscopic. Under film topography it should not understood the surface roughness of the film web, but the shape of the film web or the contour of the film web. Here, the film topography can be meant as a two-dimensional or three-dimensional film topography, as demanded.

The “film web” can either be a single-layer film web or a tubular web, wherein the hose pipe is separated or remains with tubular shape. Furthermore, a folded tube may also be referred to as a film web. The film web can be single-layered or multi-layered, in any position.

A “film section” is considered as the logical/abstract trajectory of the film and not understood as the foil itself. The film may be on the film section. But, the film must not be located on the film section. The film section is a “designated running section of the film web”.

A “radiation source” is any natural or physical-technical origin of radiation.

A “light source” is a natural or physical-technical origin of electromagnetic radiation, in particular of light. A light source is considered a light source, i.e. a light source of any frequency and intensity of the wavelength distribution. Thus, the light source can therefore emit also for humans visible light as well as for humans not visible light. In particular a light source means laser light, white light, LED light or infrared light. Furthermore, a light source means also a combined source for different types of light of any combination.

A “sensor” or “detector” is a technical component that can detect certain physical

or chemical properties and/or the physical nature of its surroundings, qualitatively or quantitatively as a “measured value”. These values are detected by physical or chemical effects and are transformed in an analog or digital electrical signal.

A “radiation pattern” is a pattern of radiation, especially electromagnetic radiation. A “pattern” is a structure, in particular a static structure, which can be recognized by their renewed identical appearance.

A “data detection system” is used to record physical values. Depending on the used sensor it has an analog-to-digital converter and a measurement value memory or data memory. The data detection system can detect several measurement

values captured in parallel.

A “data processing and evaluation unit” is an electronic unit that operates with data volumes in organized manner while pursuing the goal of gain information about these data volumes or to change these data volumes. The data are recorded in data records, according to a procedure predefined by human or machine and are output as a result.

A “triangulation method” is a geometric method for optical distance measurement by accurate angle measurement within triangles. With a triangulation method surfaces can therefore be measured by determining the positions of individual points. In the case of a film web, light is projected onto the film and by means of triangulation of the reflected light the position of individual surfaces points are determined, wherein the film topography is determined and evaluated.

A “reflection method” uses the properties of the reflection of waves on an interface at which the characteristic impedance or refractive index of the spread out medium changes, to evaluate the properties of a medium. Normally, during reflection only a part of the energy of the incident wave is reflected. In the case of a film web, light is projected onto the film and the reflection is observed with a matrix camera. The considered reflection image is used to determine and evaluate the film topography.

A “transmission method” is a method in which the permeability of a medium for waves is evaluated by the transmittance. Meets a wave to a different medium of finite thickness, it will be reflected according to the properties of the substance of the medium at the interfaces partially and will be absorbed when crossing, completely or partially. The remainder is transmitted due to the different medium and appears on the opposite side of the differing medium. The film topography is determined and evaluated based on the reflected light, which is detected with a matrix camera.

Based on the “degree of transmission” as the quotient of the wave intensity behind and before the deviating medium, properties of the deviating medium can be determined.

The state of the art, so far, has provided that the film topography of a film web

was evaluated predominantly, qualitatively. For this purpose, the film topography was made visible based on an about 10 meters long piece cut out of the film web, which was spread on the floor and swept. For quantification, in some cases, a piece of film can also be cut into narrowed longitudinal strips and, on the basis of the differences in length, the degree of fault can be evaluated in the film topography. For both methods, the process procedure does not allow a rapid adjustment for the current film production. Furthermore, both methods do not quantify a film topography. A qualified measuring method for the film topography is currently not known in the state of the art.

Deviating, is proposed here, to detect quantitatively the two- or three-dimensional film topography of a film web produced in the blown or cast film process with a measuring device consisting of a radiation source, in particular a light source, a detector and a data processing and evaluation unit, wherein the data processing and evaluation unit has a programming, whereby the programming is performed for carrying out a triangulation method and/or a reflection method and/or a transmission method for determining the film topography.

The invention thus describes a method for unambiguous flatness position determination of flexible films. The aim of the method is a flatness position measurement on films, which can supply a quantitative value only for the flatness position and is not superimposed with other influences.

or this, either the influence of the factors, that have affected originally the fault image flatness position, must be isolated from other influencing factors. If that is not possible, the flatness position is calculated on the basis of an algorithm from the superimposed measurement result.

A preferred embodiment can be realized in that the radiation source and the detector have a different position, the radiation source projects a radiation pattern onto a designated running section of the film web, and the detector is adapted to detect the projected radiation pattern.

Preferably, the detector is focused on the radiation pattern projected onto the running section of the film web.

An optional embodiment makes it possible for the measuring device, to detect the film topography, inline quantitatively, of a film web made by the blown or cast film process.

Thus, it is conceivable, among other things that the film topography of the film web can be passed in real time in the form of digital data from the measuring device.

In a preferred embodiment, the radiation pattern projected onto the designated running section of the film web this is a simple line, wherein the line can run, in particular, at the level of the designated running section of the film web as a straight line.

Advantageously, it can achieve thereby that a two- or three-dimensional film topography of a film web produced in the blown or cast film process can be detected quantitatively.

Furthermore, it can be advantageously achieved that the detected film topography is digitally stored and/or further processed and/or can be used for improving the product property of the film web.

The radiation source and the detector are preferably positioned in a common housing.

Thus, it is conceivable, inter alia, that the radiation source and the detector are interconnected in a particularly rigid housing are.

Thereby, it can be advantageously achieved that the measuring device consisting of

radiation source and detector is less susceptible to external influences, in particular against misalignment of the measuring device.

Furthermore, it can be advantageously achieved that a change in position of the measuring device can be performed more easily by translation and/or rotation.

Advantageously, it can also be achieved that the measuring device can be protected robustly in a common housing, whereby the measuring device, on the one hand,

can be protected from operating materials and/or from other environmental influences and, on the other hand, can not be adjusted unintentionally.

Optionally, the radiation pattern projected onto the designated running section of the film web runs across the machine direction across the entire width of the designated running section of the film web.

Conceptually, the following is explained:

The “machine direction” is the direction in which the designated running section of the film web runs through the machine. In particular, the machine direction is not a global direction, but it can change with the designated running section of the film web

through the machine.

Advantageously, doing so, it can be achieved that the film topography can be detected quantitatively on the complete width of the film web.

Preferably, the radiation pattern projected onto the designated running section of the film web extends in the machine direction and has a length.

Conceptually, the following is explained:

The “length” of the radiation pattern is to understand as the design of the radiation pattern on the designated running surface of the film web through the machine. In particular, the running surface can be equal to the running section. In particular, the

length can be variable.

Advantageously, thereby it can be achieved that the three-dimensionality of the film topography can be better detected.

Optionally, the radiation pattern projected onto the designated running section of the film web runs with an angle diagonally across the designated running section of the film web.

Advantageously, it can be achieved thereby that the components of the measuring device must not be positioned above and/or below the designated running section of the film web.

Preferably, an adjustment device is provided for the angle.

onceptually, the following is explained:

An “adjustment device” is a device that is performed to adjust/change something. In particular, an adjusting device is a device for adjusting the angle.

Advantageously, it can be achieved thereby that the measuring device can simply be adjusted on different film widths.

Optionally, the device has a second detector, which is also connected to the data

processing and evaluation unit and comprises a position which is different from the radiation source has.

Advantageously, doing so, it can be achieved that the three-dimensionality of the film topography can be better detected. In particular, the height coordinate of the film topography can be detected with a lower measurement inaccuracy.

According to a second aspect of the invention, the object is solved by a plant for manufacturing a film web, wherein the plant comprises an extruder for plasticizing a thermoplastic, a nozzle for the exit of the plastic, a deflection part and a winder, wherein the plant has a measuring device for inline measuring of a two-dimensional or three-dimensional film topography according to one of the preceding claims.

Conceptually, the following is explained:

“nozzle” is a device that is adapted to allow that a plastic can be outputted. In particular, a nozzle means a wide slot nozzle or a ring slot nozzle. A nozzle may have a plurality of actuators configured to adjust a nozzle gap.

It is understood that the advantages of a measuring device for measuring a two-dimensional or three-dimensional film topography produced by a blown or cast film process film web with a radiation source, in particular a light source, a detector and a data processing and evaluation unit, as described above, can be extended

directly to a plant for producing a film web, wherein the plant a comprises an extruder for plasticizing a thermoplastic, a nozzle for outputting the plastic, a deflection part and a winder, wherein the plant comprises a measuring device for inline measuring a two-dimensional or three-dimensional film topography according to a first aspect of the invention.

It should be expressly understood that the subject matter of the second aspect can be advantageously combined with subject matter of the first aspect of the invention.

According to a third aspect of the invention, the object is solved by a plant for manufacturing a film web, wherein the plant comprises an extruder for plasticizing a thermoplastic plastic, a nozzle to exit the plastic, a deflection part, a winder and a measuring device for inline measuring a two-dimensional or has three-dimensional film topography according to a first aspect of the invention, wherein the system uses an influencing element affecting on a property and/or an orientation of the film web, in particular, the influencing element comprises an influencing device, wherein the measurement of the film topography takes place in the influence area of the influencing element, wherein the influencing element is configured to reduce an error image of a second error, in particular completely, in order to conclude to the dimension of the first error, via a—due to the influencing process more increasing—error image of a first error compared with the error of the second error.

Conceptually, the following is explained:

n “influencing element” consists of a device, in particular an “influencing device”.

and a method, in particular an “influencing method” to influence a property and/or an orientation of a film web. The area of influence of the influencing element can be spatially limited. An influence by the influencing element is reversible and/or irreversible with respect to a property and/or an orientation of a film web. In particular an influencing element affects the film topography of a film web.

An “error” is the deviation of a condition which determined related to the desired condition. Here especially is meant an error in the two-dimensional or three-dimensional film topography. An error describes thus a two-dimensional or three-dimensional deviation from the desired film topography.

An “error image” is a two-dimensional or three-dimensional representation of an

error.

The state of the art has, so far, provided that a film web, depending on the embodiment of a blown or cast film was guided through a treatment section, in which

influences with reversible and/or irreversible consequences for a property and/or an orientation have been influenced.

The prior art did not provide that within a treatment section the two-dimensional or three-dimensional film topography of a film web has been detected.

By way of derogation, here, a plant for producing a film web is proposed, wherein

the plant comprises a measuring/measurement device for inline measuring a two-dimensional or three-dimensional film topography according to a first aspect of the invention and the measurement of the film topography is performed in the influence area of an influencing element.

The film topography of a film web often has several error images which can be dependent or independent on each other.

Advantageously, it can be achieved that the plant with influencing element proposed here that an error image of a second error can be reduced, in particular complete, so that the error image of a first error, compared with a measurement of a film topography outside the area of influence of an influencing element, can be detected

more accurate or equally well.

In a particularly advantageous embodiment, it can be achieved that the error images, that do not contribute to the error image of a flatness position of a film, can be reduced or can be prevented.

The tensile stress fluctuations in the film web are preferred reduced with the aid of a

regulation of a dancer roll.

Conceptually, the following is explained:

A “regulation” is an interaction of continuous detection of a measured value and the

control of a system as a function of a specification for the measured value. It occur a continuous comparison of the measured value and the setpoint for the measured value.

A “dancer roller” is a roller that is configured to keep constant the tension in a film web. In particular, a dancer roller is configured to reduce fluctuations in the tension course.

Thus, it is concretely possible, among other things that the tension fluctuations in the film web are reduced by a regulated/controlled dancer roller and thus the tensile stresses in the film web are kept constant. In particular, the controller can be configured so that it works faster and more accurately than a conventional PID controller.

Advantageously, doing so, it can be achieved that an error image of a second error can be reduced, especially complete, so that the error image of a first error,

compared to a measurement of a film topography outside the area of influence of an influencing element, can be detected more accurately or equally well.

Optionally, the stresses in the film web are isolated with a nip before and/or after the film topography measurement.

Conceptually, the following is explained:

A “nip” is a pair of rollers that is configured to have a designated running section of the film web between the pair of rollers.

Thus, it is concretely conceivable, among other things, that the stresses in the film web can be influenced and isolated with a nip before and/or after the film topography measurement.

Advantageously, thereby, it can be achieved that an error image of a second error can be reduced, especially completely, so that the error image of a first error can be detected—compared to a measurement of a film topography outside the area of influence of an influencing element—more accurately or equally well.

Tensions in the film web occur with a nip before and/or after the film topography measurement targeted in the film web.

Advantageously, in this way, it can be achieved that an error image of a second error can be completely reduced, in particular, so that the error image of a first error

compared to a measurement of a film topography outside the area of influence of an influencing element—can be detected more accurately or equally well.

Optionally, the tensile stresses in the film web can be set targeted to the ideal tension level with a nip before and/or after the film topography measurement.

An ideal tensile stress level results in such a way that the error image of a second error, in particular, can be completely reduced.

Advantageously, doing so, it can be achieved that an error image of a second error can be in particular completely reduced, so that the error image of a first error

compared to a measurement of a film topography outside the area of influence of an influencing element—can be detected more accurately or equally well.

The film topography measurement preferably takes place after a web centre control, which forces a centric run-in of the film web in the film topography measuring system.

Conceptually, the following is explained:

A “web centre control” is a device that is configured to guarantee a centric

run-in in a designated running section of the film web and/or to assist with the help of regulatory operation.

Advantageously, doing so, it can be achieved that an error image of a second error

can be reduced especially complete, so that the error image of a first error
compared to a measurement of a film topography outside the area of influence of an influencing element—can be detected more accurately or equally well.

Optionally, the film topography measurement is carried out before or after a deflection roller.

Conceptually, the following is explained:

A “deflection roller” is a roller on which the designated running section of the film web

has a change in direction.

Advantageously, it can be achieved thereby that an error image of a second error—can be reduced especially complete, so that the error image of a first error

compared to a measurement of a film topography outside the area of influence of an influencing element—can be detected more accurately or equally well.

The film topography measurement preferably takes place after a spreader section element.

Conceptually, the following is explained:

A “spreader section element” is a device for influencing a film web, which is configured to stretch the width of a film web. The width of the film web can thereby be reversible and be in the elastic area of the material behaviour of the plastic

be stretched so that the width of the film web behind the influence area of the spreader section element corresponds to the width of the film web before the influence area of the spreader section element. However, the width of the film web can also be stretched irreversible and be stretched in plastic (German: plastischen) range of material behaviour of the plastic, so that the width of the film web behind the influence area of the spreader section element is greater than the width of the film web before the influence area of the spreader section element.

In a particularly preferred embodiment, the evaluation of the film topography takes place within the area of influence of the spreader section element of the film web.

Thus, among other things by the use of a spreader section element it can be reduced or avoided a wrinkling in the film web due to transverse contraction as a result of the tensile load on the film web.

Advantageously, this can be achieved that an error image of a second error can be reduced especially completely, so that the error image of a first error—compared to a measurement of a film topography outside the area of influence of an influencing element—can be detected more accurately or equally well.

Optionally, the film topography measurement is carried out after a seam station.

Conceptually, the following is explained:

A “seam station” is a device that is configured, to seam one or both film edge regions of the film web, that is to say to cut one or both film edge regions and to take out the section.

It is conceivable, among other things that the determination of the film topography is behind a seam station, whereby the film web has a constant film width and/or the inhomogeneity is reduced at the edge regions in the film web or is avoided.

Advantageously, it can be achieved thereby that an image pattern of a second error can be reduced especially complete, so that the error image of a first error

compared to a measurement of a film topography outside the area of influence of an influencing element—can be detected more accurately or equally well.

The film topography measurement preferably takes place behind a slit device.

Conceptually, the following is explained:

A “slit device” is a device that is configured to cut one or both film folds of the film web.

Advantageously, this can be achieved that an error image of a second error can be reduced especially complete, so that the error image of a first error—compared to a measurement of a film topography outside the area of influence of an influencing element can be detected more accurately or equally well.

Furthermore, it can be advantageously achieved that the measurement of the film topography can be carried out on a single film layer, whereby any influences from a second layer of film web can be excluded.

Optionally, the film topography measurement occurs after a tension measuring roller.

Conceptually, the following is explained:

A “draw measuring roller” is a device configured to measure the tension force on a film web, whereby also the tensile stresses in the film web can be detected.

Thus, it is conceivable, among other things, that the film topography measurement takes place behind a tensile measuring roller, and the measured value of the tensile measuring roller is used to control or regulate the tension force, that acts on the film web at the place of tensile measuring roller. Thus, the level of traction can be adjusted within the range in which the film topography measurement is performed.

Advantageously, doing so, it can be achieved that an error image of a second error can be reduced especially complete, so that the error image of a first error

compared to a measurement of a film topography outside the area of influence of an influencing element—can be detected more accurately or equally well.

It should be expressly understood that the subject matter of the third aspect can be advantageously combined to the subject matter of the above aspects of the invention, namely either individually or in any combination cumulatively.

According to a fourth aspect of the invention, the object is solved by a method for inline pattern recognition of error images in a two- or three-dimensional film topography a film web which is produced in the blown film or cast film process, wherein a two-dimensional or three-dimensional film topography is determined inline as a measured value, in particular with a measuring device according to the first aspect of the invention, the measured film topography is passed to a data processing and evaluating unit, the data processing and evaluation unit classifies the film topography using a pattern recognition algorithm based on a database with predetermined pattern properties, systematically compared, wherein the error images comprising the pattern are separated are identified the error images.

Conceptually, the following is explained:

A “sensor” or “detector” is a technical component which can specifically detect physical or chemical properties and/or the material nature of its environment qualitatively or quantitatively as a “measurement variable”. These variables are detected by means of physical or chemical effects and are transformed in an analog or digital electrical signal.

A “measured value” is the instantaneous value of a “measurement variable”. A “measurement variable setpoint” is the setpoint value for a measurement variable.

A “data base” is an electronic data management system. The object of the data base is to store large amounts of data efficiently, without contradiction and permanently and to provide required subsets of the stored data in different, demand-fair representation for users and application programs.

A “pattern” or “error pattern” refers to an error structure. The error structure

consists of one or more overlapping error images. In the course of this patent registration, the properties of the error pattern are executed. From a pattern one or more error images can be identified by their properties.

A “pattern property” includes all objectively and subjectively perceptible properties of the pattern.

An “algorithm” is a clear operation instruction for solving a problem or a class of problems. The algorithm consists of finitely many, well-defined individual steps. Thus, they can be implemented for execution in a computer program, but also be formulated in human language. In problem solving a particular input is transferred to a particular output.

The prior art has heretofore provided that the operator of a blown or cast film

plant visualizes patterns in the film topography and compares qualitatively corresponding to its experience and to his heuristic knowledge conditions which are familiar to him.

By way of derogation, an automated method is proposed here which classifies patterns of error images in a two- or three-dimensional film topography of a film web with a pattern recognition algorithm based on a data base of predefined pattern properties, systematically comparing, and separates the error images in the pattern and identifies the error images.

In other words, it is proposed to automatically analyze a film topography of a film web

based on the predetermined pattern characteristic, and so to show the error images in the topography and to evaluate their respective characteristics.

Among other things, it is conceivable that the data base is build from linearly independent error images and from error images which are composed from the possible combinations of linearly dependent error images, so that a clear characterization of the occurring error images can be realized.

It is also conceivable, inter alia, that the automatic method can compare the measured film topography pattern with the film topography patterns contained in the data base and selects the film topography pattern with the at least deviation, compared with the measured film topography pattern.

Furthermore, it is concretely conceivable, among other things, that the database comprises characteristic features of film topography patterns and their characteristics, in particular the orientation of elevations in the film topography, the maximum deflection of an elevations, the distance between two elevations and other characteristic features of a film topography pattern, and uses an algorithm in order to assign error images based on this data to the measured film topography.

Characteristic features of an error image are, in particular, also the number of error spots over the width of a film web, the manner in which an error spot occurs, in particular a continuous occurrence or a cyclical occurrence and/or an increasing or decreasing manifestation of occurrence.

Furthermore, the position of an error spot on the film web is a characteristic feature of

an error image, in particular a helical or straight-line distributed position of the error image and/or a distribution of error spots across the web or along the web or a distribution of error spots under an angle, in particular under an angle greater than 1° but less than 89°, deviation from the machine direction.

Of course, it is also possible that the measured film topography has just an error image or even no error image, the latter especially in a completely flat film sheet.

The objective of the method is, inter alia, to separate error in a measured film topography, to identify them later, and to evaluate the manifestation of the

error images.

In a particularly advantageous embodiment, the algorithm divides the recognized

pattern in individual patterns, stores this data, leads them to an evaluation unit and matches them with historical data.

Furthermore, in a particularly preferred embodiment, possible causes with respect to individual error images and possible corrective actions can be stored in the data base.

Advantageously, doing so, it can be achieved that the pattern in the film topography can be automatically recognized and be assigned to one or more superimposed error images.

Furthermore, it can advantageously be achieved that the manifestation of an error image can be detected automatically.

In addition, it can be advantageously achieved that the data base comprises possible countermeasures and offers to the machine operator promising countermeasures for avoiding an error image.

Preferably, the predefined pattern characteristics include a number of error/defects spots over the width of the film web.

Conceptually, the following is explained:

An “error spot” is an unevenness in a film topography with a central plane.

It can advantageously be achieved hereby that the pattern in the film topography

can be recognized automatically based on the number of errors in the film topography over the width of the film web and can be automatically assigned to one or more superimposed error images with the corresponded measure of their proportion of manifestation, causing that the accuracy of inline pattern recognition increases.

Optionally, the predefined pattern characteristics include a continuous or cyclic occurrence of error images.

It is conceivable, among other things, that inline pattern recognition uses the characteristic of the occurrence of error images for characterizing the errors, in particular a continuous or cyclic occurrence of error images.

Thus, it can advantageously be achieved that the pattern being used in the film topography is recognized automatically based on predefined pattern properties and is assigned to one or more overlapping error images with the respective degree of their manifestation, in particular a cyclical or continuous occurrence of defects/errors in the film topography can be used as a characteristic feature of the pattern in the film topography, thereby increasing the accuracy of the inline pattern recognition.

Preferably, the predefined pattern properties include an increasing or decreasing

manifestation of error images.

It is conceivable, among other things, that inline pattern recognition uses the characteristic of predefined pattern properties to characterize the error, in particular

an increasing or decreasing manifestation of error images.

Thus, it can advantageously be achieved that the pattern in the film topography is recognized automatically via predefined pattern properties and can be assigned automatically to one or more superimposed error images with the respective degree of their manifestation, in particular an increasing or decreasing manifestation of error images in the film topography can be used as characteristic feature of the pattern in the film topography, whereby the accuracy in inline pattern recognition increases.

Optionally, the predefined pattern properties include a position of the error images on the film web.

It is conceivable, among other things, that inline pattern recognition uses a characteristic position of error images on the film web to characterize the errors.

Advantageously it can be thereby achieved that the pattern being in the film topography via predefined pattern properties can be automatically recognized and one or more superimposed error images can be assigned automatically with the respective degree of their manifestation, in particular therefore a position of error images in film topography can be used as a characteristic feature of the pattern in the film topography, thereby increasing the accuracy of inline pattern recognition.

Preferably, the predefined pattern properties include helical course of the error images on the film web.

It is conceivable, among other things, that inline pattern recognition uses a characteristic course of error images on the film web over the width of the film web

and uses the track of the film web to characterize the errors, in particular a helical course of the error images.

Advantageously it can be thereby achieved that the pattern in the film topography is recognized automatically via predefined pattern properties and can be assigned to one or more superimposed error images with the respective degree of their manifestation, in particular a helical course of error images in the film topography can be used as a characteristic feature of the pattern in the film topography, thereby increasing the accuracy of inline pattern recognition.

Optionally, the predefined pattern properties include a rectilinear course of the error images on the film web.

It is conceivable, among other things, that the inline pattern recognition uses a characteristic course of error images on the film web across the width of the film web

and/or uses the track of the film web for characterizing the errors, in particular a straight-line course of the error images.

Advantageously, doing so, it can be achieved that the pattern being in the film topography is automatically recognized via predefined pattern properties and is assigned automatically to one or more superimposed error images with the respective degree of their manifestation, in particular, therefore, a straight-line course of error images in the film topography can be used as a characteristic feature of the pattern in the film topography, thereby increasing the accuracy of inline pattern recognition.

Preferably, the predefined pattern properties include a position of the error images on the film web in relation to the film width.

It is conceivable, among other things, that inline pattern recognition uses the characteristic of predefined pattern properties to characterize the error, in particular

a position of the error images on the film web with respect to the film web width.

Advantageously, it can be thereby achieved that the pattern in the film topography can be automatically recognized via predefined pattern properties and can be assigned automatically to one or more superimposed error images with the respective degree of their manifestation, in particular therefore a position of the error images on the film web can be used with respect to the film web width in the film topography as a characteristic feature of the pattern in the film topography, thereby increasing the accuracy of inline pattern recognition.

Optionally, the predefined pattern properties include a position of the error images

on the film web in relation to the machine direction.

It is conceivable, among other things, that inline pattern recognition uses the characteristic of predefined pattern properties to characterize the errors, in particular

a position of the error images on the film web with respect to the machine direction.

Advantageously, it can be thereby achieved that the pattern in the film topography is

automatically recognized via predefined pattern properties and can be assigned automatically to one or more superimposed error images with the respective degree of their manifestation; in particular, a position of the error images therefore may be used on the film web with respect to the machine direction in the film topography as a characteristic feature of the pattern in the film topography, thereby increasing the accuracy of inline pattern recognition.

Preferably, the predefined pattern characteristics include an orientation of

the error images with respect to an angle between 1° and 89° to the machine direction on the film web.

It is conceivable, among other things, that inline pattern recognition uses the characteristic of predefined pattern properties to characterize the error, in particular

the orientation of the error images with respect to an angle between 1° and 89° in machine direction on the film web.

Advantageously, doing so, it can be achieved that the pattern in the film topography is recognized automatically via predefined pattern properties and can be assigned automatically to one or more superimposed error images with the respective degree of their manifestation, in particular, an orientation of the error images

on the film web can be used with respect to an angle between 1° and 89° to the machine direction on the film web in the film topography as a characteristic feature of the pattern in the film topography, thereby increasing the accuracy of the inline pattern recognition.

Optionally, the causes of the error images are analyzed.

Thus, among other things, it is conceivable that the data base may contain possible causes of the error images and/or analyzes the causes of the error images via heuristic data in the data base.

Advantageously, it can be so achieved that to the machine operator promising

countermeasures for stopping an error image can be shown and thus the production of the film web within the desired film web properties can be improved.

Preferably, the pattern recognition algorithm is self-learning.

Conceptually, the following is explained:

By “self-learning” is meant that the algorithm learns from examples and can also generalize them. So the algorithm does not just learn examples by heart, but he recognizes patterns and laws in the learning data.

Thus, among other things, in a particularly preferred embodiment it is possible that

the pattern recognition algorithm can also evaluate unknown data.

Advantageously, it can be thereby achieved that the algorithm fills gaps in the data base itself and/or analyzes automatically and/or recognizes possible causes of the error images even in previously unknown error images.

Optionally, the pattern recognition algorithm learns by inputs of the machine operator.

So it is conceivable, among other things, that the machine operator when a

pattern of a error image occur that is familiar to him, that the data base is completed with information of the error image.

Advantageously, doing so, it can be achieved that the inline pattern recognition is completed quickly with the knowledge existing so far by the machine operators, thereby increasing the accuracy of inline pattern recognition.

The database preferably contains the pattern properties causes from the individual error images.

Advantageously, it can be thereby achieved that to the operator of the plant for the production of a film web one or more causes for the occurrence of an error image

are communicated, so that these can be corrected faster and/or can be corrected while maintaining a defined error clearing process, by the operator.

Furthermore, it can be so advantageously achieved that a method can be made possible, which enables the plant to turn off a cause for the occurrence of an error images independently, so that the quality of the production of film webs can be improved automatically.

Optionally, the data base contains the pattern properties for each error images

recommended actions for stopping or reducing an error image by changing from a setting variable in the manufacturing process of the film web.

Conceptually, the following is explained:

An “actuator element” or “actuator” is particularly suitable for an affecting an output variable of a system.

A “setting variable” is the output variable of the actuator. The actual value of the setting variable is a “set value”.

Thus, it is concretely conceivable, inter alia, that the plant for producing a film web

via their electronic control—gives recommendations for the operation for the stopping or reducing of an error image to the plant operator,
in particular operation recommendations for changing a setting variable in the manufacturing process of film webs.

Advantageously, doing so, it can be achieved that to the operator of the plant for manufacturing a film web one or more causes for the occurrence of an error image

and the necessary change in a setting variable in the production process of the film web can be communicated, so that the cause can be corrected faster and/or while maintaining a predefined error clearance process by changing a setting variable by the operator can be corrected.

Furthermore, advantageously, a method can be made possible, with which the situation is made possible by which the plant is able to turn off a cause for the occurrence of an error image, so that the quality in the production of film webs automatically can be improved.

In the production process, the setting variable preferably contains a recipe of the thermoplastic plastic.

Conceptually, the following is explained:

A “recipe” is a specific composition of a thermoplastic art substance in the mixing ratio of its constituents.

It is concretely conceivable, inter alia, that the plant for producing a film web

via their electronic control—gives to the plant operator operation recommendations for the turning off or reducing an error image by changing a setting variable due to the changing of a setting variable of the manufacturing process of film webs, in particular for influencing the recipe of the thermoplastic material.

Advantageously, doing so, it can be achieved that to the operator of the plant for manufacturing a film web one or more causes—for the occurrence of an error image

and the necessary change of a setting variable in the production process of the film web—can be communicated, so that the cause can be faster corrected and/or while maintaining a predefined error clearance process by changing a setting variable by the operator can be corrected, in particular by changing a setting variable for influencing the recipe of the thermoplastic material.

Furthermore, it can advantageously be achieved that a method can be made possible, which enables the plant to turn off a cause for occurring of an error image independently, so that the quality in the production of film webs can be improved automatically.

Optionally, the setting variable in the manufacturing process contains a nozzle cross-section for outputting the plastic.

It is concretely conceivable, inter alia, that the plant for producing a film web

gives to the plant operator via their electronic control operation recommendations for the turn off or reducing an error image by changing a setting variable in the manufacturing process of film webs, in particular the changing of a setting variable for influencing the nozzle cross section for the exit of the plastic.

Advantageously, doing so, it can be achieved that to the operator of the plant for manufacturing a film web one or more causes for the occurrence of an error image

and the necessary change of a setting variable in the production process of the film web can be communicated, so that the cause is faster corrected and/or while maintaining a predefined error clearance process by changing a setting variable is corrected by the operator, in particular by changing a setting variable for influencing the nozzle cross-section for the exit of the plastic.

Furthermore, it can advantageously be achieved that a method can be made possible, which enables the plant to turn off a cause for occurring of an error image independently, so that the quality in the production of film webs can be improved automatically.

In the production method, the setting variable preferably includes the setting of a flatness position part.

Conceptually, the following is explained:

A “flatness position part” is a device that is adapted to put together a film tube into a doubly flattened film web.

It is concretely conceivable, inter alia, that the plant for producing a film web—via their electronic control—gives to the plant operator operation recommendations for the turn off or reducing an error image by changing a setting variable in the manufacturing process of film webs, in particular the changing of a setting variable for influencing a setting of the flat-laying.

Advantageously, thereby, it can be achieved that to the operator of the plant for manufacturing of a film web can be communicated one or more causes for the occurrence of an error image and the necessary change in a setting variable in the production process of the film web, so that the cause can be by the operator corrected faster and/or while maintaining a predefined error clearance process by changing a setting variable can be turned off by the operator, in particular by changing a setting variable for influencing a setting of the flat-laying.

Furthermore, it can advantageously be achieved that a method can be made possible, which enables the plant to turn off a cause for occurring of an error image independently, so that the quality in the production of film webs can be improved automatically.

Optionally, the setting variable in the manufacturing process includes the setting of a side guide part.

Conceptually, the following is explained:

A “side guide part” is a device that is configured to guide a film web so that it keeps its specific orientation.

It is concretely conceivable, inter alia, that the plant for producing a film web—via their electronic control—gives to the plant operator operation recommendations for the turn off or reducing an error image by changing a setting variable in the manufacturing process of film webs, in particular the changing a setting variable for influencing a setting of the side guide part.

Advantageously, thereby, it can be achieved that to the operator of the plant for manufacturing of a film web can be communicated one or more causes for the occurrence of an error image and the necessary change in a setting variable in the production process of the film web, so that the cause can be by the operator corrected faster and/or while maintaining a predefined error clearance process by changing a setting variable can be turned off by the operator, in particular by changing a setting variable for influencing a setting of the side guide part.

Furthermore, it can advantageously be achieved that a method can be made possible, which enables the plant to turn off a cause for occurring of an error image independently, so that the quality in the production of film webs can be improved automatically.

In the production method, the setting variable preferably includes the setting of a flatness position actuator.

Conceptually, the following is explained:

A “flatness position actuator” is a device that is adapted to influence the flatness position of a film web.

It is concretely conceivable, inter alia, that the plant for producing a film web—via their electronic control—gives to the plant operator operation recommendations for the turn off or reducing an error image by changing a setting variable in the manufacturing process of film webs, in particular the changing of a setting variable for influencing a setting of the flatness position actuator.

Advantageously, thereby, it can be achieved that to the operator of the plant for manufacturing of a film web can be communicated one or more causes for the occurrence of an error image and the necessary change in a setting variable in the production process of the film web, so that the cause can be by the operator corrected faster and/or while maintaining a predefined error clearance process by changing a setting variable can be turned off by the operator, in particular by changing a setting variable for influencing a setting of the flatness position actuator.

Furthermore, it can advantageously be achieved that a method can be made possible, which enables the plant to turn off a cause for occurring of an error image independently, so that the quality in the production of film webs can be improved automatically.

Optionally, the setting variable in the manufacturing are divided into segmented setting zones.

Conceptually, the following is explained:

A “segmented setting zone” is a device for adjusting a setting variable, wherein

the setting variable can be adjusted segment by segment.

Thus, it is concretely conceivable, inter alia, that the setting variable can be adjusted depending on another manifestation, in particular depending on the film width.

Advantageously, this can be achieved that the setting variable can be adjusted in dependence of a further manifestation, in particular depending on the film width,

wherein the possibilities of influencing an error image can increase and the change of a setting variable can be better performed according to demand depending on a further manifestation.

It should be expressly understood that the subject matter of the fourth aspect can be advantageously combined with the subject matter of the above aspects of the invention, namely either individually or in any combination cumulatively.

According to a fifth aspect of the invention, the object is solved by a method for controlling the production process of a film web for preventing error images, wherein a pattern recognition method is applied according to the fourth aspect of the invention

and a recommended action/operation from the database of pattern recognition can be used automatically to control the manufacturing process of the film web.

Conceptually, the following is explained:

A “control” is an adjustment of a setting variable.

A “disturbance variable” is a parameter that has a deviation from its ideal state.

It is concretely conceivable, inter alia, that the plant for producing a film web

with the help of inline pattern recognition according to the fourth aspect of the invention in the film topography of the film web—detects occurring errors/defects, that takes from the data base a operation recommendation for reducing or preventing the error Image depending of the error image of a setting variable of the plant for producing a film web, and controls as a function the difference between the action recommendation and the actual setting variable resulting change in the setting variable.

In a preferred embodiment, the method can be used to recognize a flatness position error via its characteristic error image in the film topography by means of the inline pattern recognition according to the fourth aspect of the invention, and to reduce or eliminate its manifestation by an automated control intervention on a setting variable of the plant for producing a film web.

Specifically, it is conceivable, inter alia, that the data base contains a setting variable combination, with which error images are avoided.

In a preferred embodiment, the method can be used to detect error image in the film topography—which is characterized by wrinkles in the film web—by means of the inline pattern recognition according to the fourth aspect of the invention and to reduce or eliminate its manifestation, by an automated control intervention on a setting variable of the plant of the production of a film web.

In a particularly advantageous embodiment, the data base learns by feedback

of the operator, so that an error image can advantageously be recognized even better in the future and a correspondingly effective countermeasure can be made.

A possible error image, which can be reduced in its manifestation advantageously with the controller, is in the machine direction occurring wrinkles in the film web.

Possible causes of this error image (fault pattern) are a too high or a too low tensile stress in the film web, an impermissible temperature in the film web and/or an unacceptable or defective width spreader element in the plant for producing the film web.

A possible error image, which can be advantageous reduced with the controller in its manifestation, are occurring wrinkles in the film web, which can deviate with an angle from 2° or more but less than 89° from the machine direction. Possible causes of this error image are a bad or inadequate orientation of the plant for producing the film web, a bad or inadequate orientation of a roller or a deflection roller and/or a too high and/or non-uniform contact pressure in a nip of the plant for producing the film web.

It should be understood that the benefits of a method for inline pattern recognition of

error images in a two- or three-dimensional film topography of a film web, which is produced in the blown film or cast film process, according to the fourth aspect of the invention, as described above, can be extended directly to a method for controlling the production process of a film web to prevent error images, wherein a method for pattern recognition according to the fourth aspect of the invention is applied and a recommended action from the data base of pattern recognition is used automatically to control the production process of the film web.

In addition, it can be advantageously achieved that the database contains possible countermeasures and uses them automatically to control the machine, whereby the

the occurrence/manifestation of error images or the occurrence of error images can be reduced or the occurrence of error images can be prevented, whereby the quality of produced film webs increases.

It should be expressly understood that the subject matter of the fifth aspect with

the subject matter of the above aspects of the invention can be advantageously combined, and cumulatively either individually or in any combination.

According to a sixth aspect of the invention, the object is solved by a method for controlling the production process of a film web for preventing error images, wherein a pattern recognition method according to the fourth aspect of the invention is applied

and a recommended action from the data base of pattern recognition is used automatically to control the manufacturing process of the film web.

So it is concretely conceivable, among other things, that a task which is taken from a control according to the fifth aspect of the invention, is now taken by a regulation.

In a particularly suitable embodiment, a setting value of a plant for producing a film web of a thermoplastic material, which leads to a film topography without error image and/or which is determined with the regulation, by regulating successfully any disturbances, is stored in a special setting variable memory, so that this setting variable can be used again for producing a film web without error images in the film topography.

It should be understood that the benefits of a method for inline pattern recognition of

error images in a two- or three-dimensional film topography of a film web, which is produced in the blown film or cast film process, according to the fourth aspect of the invention, as described above, can be extend directly to a method for regulating the production process of a film web to prevent error images, wherein a method for pattern recognition is applied according to the fourth aspect of the invention and a recommended action from the data base of pattern recognition is used automatically to control the production process of the film web.

In addition, it can be advantageously achieved that the plant regulates a smallest occurrence of occurring error images, wherein the manifestation of occurring error images is reduced, the occurrence of error images is prevented, thereby increasing the quality of the produced film webs.

It should be expressly understood that the subject matter of the sixth aspect can be advantageously combined with the subject matter of the above aspects of the invention, namely either individually or in any combination cumulatively.

According to a seventh aspect of the invention, the object is solved by a method for inline flatness position determination of a film web produced in the blown or cast film process, wherein a method for inline pattern recognition is applied according to the fourth aspect of the invention.

Defects in the flatness/flatness position (German: Planlage) are, in particular, film slack in a tension-free state and/or a bow-like form of the film web. Thus, films can exist with an ideally constant thickness, which can still have a flatness error, and films can exist with a thickness deviation, which nevertheless have an ideal flatness. The cause of a flatness error lies in locally different lengths of the film web.

The prior art previously provides that the flatness position of a film web was detected based on a film sample piece. For this purpose, the flatness position of the film web was made visible based on an about 10 meters long film sample piece cut out of the film web, which was spread on the floor and swept. A more qualified measuring method for the flatness position of the film web is currently in the prior art not known.

By way of derogation, it is proposed here, that the flatness position of a film web is determined based on the manifestation of an—for a flatness error characteristic—error image in the film topography of a film web, wherein the film topography is determined with an inline pattern detection method according to the fourth aspect of the invention.

Thus, it is conceivable, inter alia, that the flatness position in the described manner is determined on a single-layer film web or a doubly flattened film web.

In a particularly suitable embodiment of the method, the flatness position of

a film web can be clearly determined.

It should be understood that the benefits of a method for inline pattern recognition of

error images in a two- or three-dimensional film topography of a film web, which is produced in the blown film or cast film process, according to the fourth aspect of the invention, as described above, can be extended directly to a method for inline flatness position determination of a film web produced in the blown or cast film process, wherein a method for inline pattern recognition is applied according to the fourth aspect of the invention.

It should be expressly understood that the subject matter of the seventh aspect can be advantageously combined with the subject matter of the above aspects of the invention, namely either individually or in any combination cumulatively.

According to an eighth aspect of the invention, the object is solved by a plant for manufacturing a film web, wherein the plant comprises an extruder for plasticizing a thermoplastic, a nozzle for the exit of the plastic, a deflection part and a winder, wherein the device comprises is a measuring device according to the first aspect of the invention, and the data processing and evaluation unit has a programming, wherein the programming is configured for performing a method according to the

fourth aspect of the invention.

It is understood that the advantages of a measuring device for measuring a two-dimensional or three-dimensional film topography of film web produced with a blown or cast film process with a radiation source, in particular a light source, a

detector and a data processing and evaluation unit as described above under the first aspect of the invention and the advantages of a method for inline pattern recognition of error images in a two- or three-dimensional film topography of a film web which is produced in the blown film or cast film process, according to the fourth aspect of the invention, as described above can be directly extend to a plant for producing a film web, wherein the plant comprises an extruder for plasticizing a thermoplastic, a nozzle for the exit of the plastic, a deflection part and a winder, wherein the device has a measuring device according to the first aspect of the invention, and the data processing and evaluation unit has a programming, wherein the programming is configured to carry out a method according to the fourth aspect of the invention.

The plant for producing a film web has preferably an influencing element according to the third aspect of the invention.

It is understood that the advantages of a plant for producing a film web, wherein the plant comprises an extruder for plasticizing a thermoplastic, a nozzle for the exit of the plastic, a deflection part, a winder and a measuring device for inline measuring a two-dimensional or three-dimensional film topography according to a first aspect of the invention, wherein the plant applies an—on a property and/or an orientation of the film web acting—influencing element, wherein, in particular, the influencing element has an influencing device, the measurement of the film topography is performed within the area of influence of the influencing element, wherein the influencing element is configured to reduce—in particular completely—an error image of a second error, via a—due to the influencing process more increasing—error image of a first error compared with the error of the second error, according to a third aspect of the invention, as described above, extend directly on a plant for producing a film web, wherein the plant comprises an extruder for plasticizing a thermoplastic, a nozzle for the exit of the plastic, a deflection part and a winder, wherein the device has a measuring device according to the first aspect of the invention, wherein the data processing and evaluation unit has a programming, wherein the programming is configured to execute a method according to the fourth aspect of the invention.

Optionally, the plant is configured for producing a film web in the form of a blown film or cast film.

Advantageously, doing so, it can be achieved that the advantages of a blown film or

cast film plant extend on a plant for producing a film web, wherein the plant comprises an extruder for plasticizing a thermoplastic, a nozzle for exit of the plastic, a deflection part and a winder, wherein the device comprises a measuring device according to the first aspect of the invention, and the data processing and evaluation unit has a programming, whereby the programming is configured for carrying out a method according to the fourth aspect of the invention.

It should be expressly understood that the subject matter of the eighth aspect can be advantageously combined with the subject matter of the above aspects of the invention, namely either individually or in any combination cumulatively.

According to a ninth aspect of the invention, the object is solved by a method for inline determination of a first error, in particular a flatness position error, of a—in a blown or cast film method produced film web by means of a two- or multi-dimensional film topography measuring method, wherein the film web has the first and a second error, wherein the method uses a—to a property and/or an orientation of the film web acting—influence, in particular an influencing element according to the third aspect of the invention, in order to reduce—in particular completely—an error image of the second error, in order to conclude to the dimension of the first error, via a—due to the influencing process more increasing—error image of a first error compared with the error of the second error.

It is understood that the advantages of a plant for producing a film web, wherein the plant comprises an extruder for plasticizing a thermoplastic, a nozzle for the exit of the plastic, a deflector part, a winder and a measuring device for inline measuring a two-dimensional or three-dimensional film topography according to a first aspect of the invention, wherein the plant uses a—on a property and/or an orientation of the film web acting—influencing element, in particular, wherein the influencing element has an influencing device, the measurement of the film topography takes place within the area of influence of the influencing element, wherein the influencing element is configured to reduce—in particular completely—an error image a second error, in order to conclude to the dimension of the first error, via an—due to the influencing process more increasing—error image of a first error compared with the error of the second error, according to a third aspect of the invention, as described above, extend directly to a method for inline determination of a first error, in particular a flatness position error, of a with the blown or cast film process produced film web by means of a two- or multi-dimensional film topography measuring method, wherein the film web has the first and a second error, wherein the method applies an—on a property and/or an orientation of the film web affecting—influence, in particular a influencing element according to the third aspect of the invention, to reduce—in particular completely—an error image of a second error, in order to conclude to the dimension of the first error, via a—due to the influencing process more increasing—error image of a first error compared with the error of the second error.

Preferably, the tensile stress variation in the film web in the area of film topography measurement are reduced by means of a regulation of a dancer roller.

Thus, it is concretely possible, among other things that the tension variation in the film web in the area of the film topographic measurement is reduced by a controlled dancer roller and thus the tensile stresses are kept constant. In particular, the

regulator/controller is configured so that it works faster and more accurate than a conventional PID regulator.

Advantageously, doing so, it can be achieved that an error image of a second error

can be reduced—in particular completely—so that the error image of a first error—compared to a measurement of a film topography outside the area of influence of an influencing element—can be detected more accurately or equally well.

Optionally, the stresses in the film web are isolated with a nip before and/or after the

film topography measurement.

Thus, it is concretely conceivable, among other things, that the stresses in the film web can be influenced and isolated with a nip before and/or after the film topography measurement.

Advantageously, doing so, it can be achieved that an error image of a second error

can be reduced—in particular completely—so that the error image of a first error—compared to a measurement of a film topography outside the area of influence of an influencing element—can be detected more accurately or equally well.

Preferably, tensions in the film web are caused with a nip before and/or after the film topography measurement specifically in the film web.

Advantageously, doing so, it can be achieved that an error image of a second error

can be reduced—in particular completely—so that the error image of a first error—compared to a measurement of a film topography outside the area of influence of an influencing element—can be detected more accurately or equally well.

Optionally, the tensile stresses in the film web are set with a nip before and/or after

the film topography measurement to the ideal tension level.

An ideal tensile stress level results in such a way that the error image of a second error can be, in particular completely, reduced

Advantageously, doing so, it can be achieved that error image of a second error can be—in particular completely—reduced, so that the error image of first error—compared to a measurement of a film topography outside the area of influence of an influencing element—can be detected more accurately or equally well.

The film topography measurement preferably takes place after a web centre control, which forces a centric run in of the film web in the film topography measuring system.

Advantageously, this can be achieved that an error image of a second error

can be—in particular completely—reduced so that the error image of a first error compared to a measurement of a film topography outside the area of influence of an influencing element can be detected more accurately or equally well.

Optionally, the film topography measurement is carried out before or after a deflection roller.

Advantageously, doing so, it can be achieved that an error image of a second error

can be—in particular completely—reduced so that the error image of a first error compared to a measurement of a film topography can be detected outside the area of influence of an influencing element more accurately or equally well.

The film topography measurement preferably takes place after a width spreader element (spreader section element).

In a particularly preferred embodiment, the evaluation of the film topography takes place within the area of influence of the width spreader element of the film web.

Thus, among other things—by the use of a width spreader element—a wrinkling

in the film web due to transverse contraction as a result of the tensile load on the film web can be reduced or avoided.

Advantageously, doing so, it can be achieved that an error image of a second error can be—especially complete—reduced, so that the error image of a first error

compared to a measurement of a film topography outside the area of influence of an influencing element can be detected more accurately or equally well.

Optionally, the film topography measurement is carried out after a seam station.

It is conceivable, among other things, that the determination of the film topography is performed behind a seam station, whereby the film web has a constant film width

and/or the inhomogeneity at the edge regions in the film web is reduced or is avoided.

Advantageously, doing so, it can be achieved that an error image of a second error

can be—in particular completely—reduced, so that the error image of a first error compared to a measurement of a film topography outside the area of influence of an influencing element can be detected more accurately or equally well.

The film topography measurement preferably takes place after a slit device.

Advantageously, doing so, it can be achieved that an error pattern of a second error

can be—in particular completely—reduced, so that the error image of a first error compared to a measurement of a film topography outside the area of influence of an influencing element can be detected more accurately or equally well.

Optionally, the film topography measurement takes place behind a tension measuring roller.

Thus, it is conceivable, among other things, that the film topography measurement takes place behind a tension measuring roller, and the measured value of the tension measuring roller is used to control or regulate the traction force, that acts on the film web at the place of the tension measuring roller. Thus, the level of traction force can be adjusted within the range in which the film topography measurement is performed.

Advantageously, doing so, it can be achieved that an error pattern of a second error can be—in particular completely—reduced so that the error image of a first error

compared to a measurement of a film topography outside the area of influence of an influencing element can be detected more accurately or equally well.

Preferably, the method is combined with a pattern recognition according to the fourth aspect of the invention.

It should be understood that the benefits of a method for inline pattern recognition of

error images in a two- or three-dimensional film topography of a film web, which is produced in the blown film or cast film process, according to the fourth aspect of the invention, as described above, can be directly extended to a method for line-determining a first error, in particular flatness position error, of a—with the blow or cast film method produced—film web by means of a two- or multi dimensional film topography measurement method, wherein the film web has the first and a second error, wherein the method applies an—based on a property and/or an orientation direction of the film web acting—influence, in particular an influencing element according to the third aspect of the invention, to reduce—in particular completely—an error image of the second error, in order to conclude to the dimension of the first error, via a—due to the influencing process more increasing—error image of a first error compared with the error of the second error.

It should be expressly noted that the subject matter of the ninth aspect can be advantageously combined with the subject matter of the above aspects of the invention, namely either individually or in any combination cumulatively.

The invention will be described below with reference to an exemplary embodiment

explained in detail on the drawing. It is shown there:

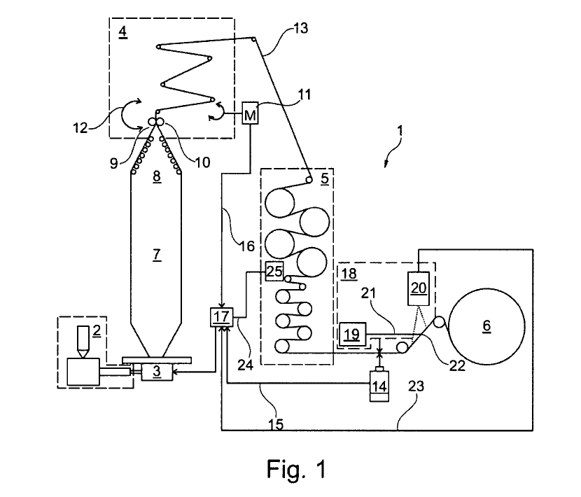

FIG. 1 shows schematically a plant for producing a film web, in particular a blown film plant, with a measuring device for measuring a film topography, in particular a blown film plant,

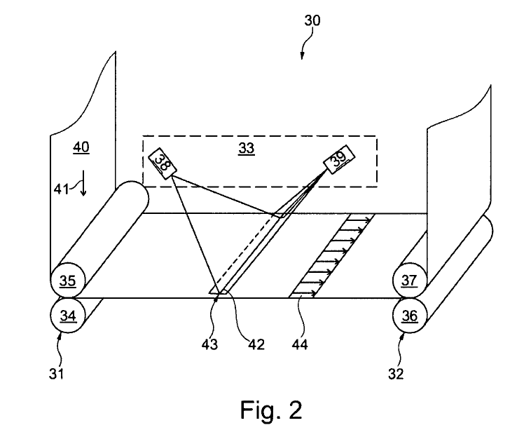

FIG. 2 shows schematically an influencing element in the area of the film topography measurement and

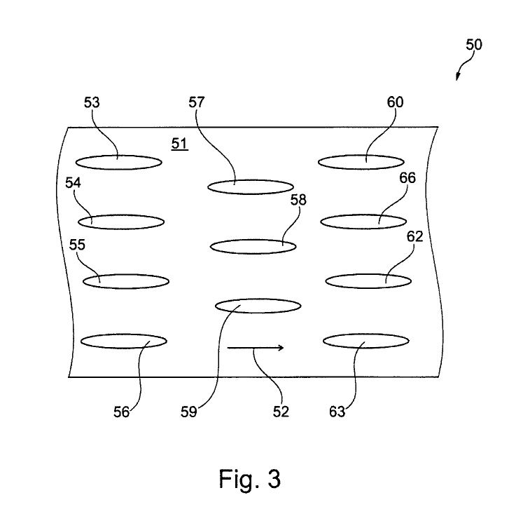

FIG. 3 shows schematically an error image.

The blown film plant 1 in FIG. 1 consists essentially of an extruder 2, a blow head 3, a reversing turn out 4, a treatment section 5 and a winder 6.

The extruder 2 conveys and plasticizes a plastic melt, which exits through a ring

gap nozzle (not numbered) in the blow head 3. The exiting plastic melt forms a film bubble 7, which is laid together in a flattening part 8 to a double laid flat film web 13.

The doubly flattened film web 13 is pulled from a turn-out roller pair 9, 10 and further passed into the reversing turn-out 4.

The reversing turn-out is driven by a motor 11 and carries out a reversing movement 12, by which deviations in the film thickness profile of the double flat laid film web 13 are moved away.

Behind the reversing turn out 4, the double flattened film web is fed to the

treatment section 5, which stretches the doubly flattened film web 13 in this embodiment monoaxially in the machine direction.

Behind the treatment section 5, the double flattened film web 13 is transmitted to the winding 6 and is wound there to a film roll.

Between the treatment section 5 and the winder 6 passes the double flattened

film web 13 to a film thickness profile measuring device 14, which determines a film thickness profile 15 of the doubly flattened film web 13.

The film thickness profile 15 of the doubly flattened film web 13 is supplied together with a reversing angle 16 of the reversing turn-out 4 of a data processing and evaluation unit 17.

The data processing and evaluation unit 17 is adapted to carry out a method for

determining a thickness distribution systematic and a method for adjusting the film thickness profile and to control the annular nozzle of the blow head 3.

Likewise, the doubly flattened film web 13 passes between the treatment section 5 and the winder 6 a film topography measuring system 18 consisting of a radiation source 19 and a detector 20.

The radiation source 19 projects a radiation pattern 21 onto the double flattened film web 13 at the position 22.

The detector 20 is adapted to detect the radiation pattern 21 on the double flattened foil web 13. In particular, the detector 20 is focused at the position 22 of film web 13.

The detected film topography 23 is electronically transmitted from the film topography measurement system 18 to the data processing and evaluation unit 17.

The data processing and evaluation unit 17 is adapted to carry out a method for inline pattern recognition of error images (not numbered) based on the measured

film topography 23.

In addition, the data processing and evaluation unit 17 is adapted to perform a process for controlling the blown film plant 1, which aims to reduce or to prevent completely error images (not numbered) in the film topography 23 in their manifestation (not numbered).

For this purpose, the data processing and evaluation unit 17 can transmit corresponding control commands to the setting variables (not quantified) and thus influences the blown film process.

In this embodiment are available as setting variables (not numbered), the gap thickness (not numbered) of the blowing head 3, the reversing movement 12 of the reversing turn out 4 and the setting variable 24 of the treatment section 5.

For this purpose, the setting variable 24 of the treatment section 5 is electronically transmitted to the control unit 25 of the treatment section 5.

The influencing element 30 in FIG. 2 consists essentially of a first nip 31 and a second nip 32 and a film topography measuring system 33.

The first nip 31 consists of a first squeeze roll 34 and a second squeeze roll 35. The second nip 32 consists of a first squeeze roll 36 and a second squeeze roll 37.

The film topography measuring system 33 essentially consists of a radiation source

38 and a detector 39. The radiation source 38 projects a radiation pattern 42 on the film web 40 at the position 43. The detector 39 is adapted to detect the radiation pattern 42 on the film web 40. In particular, the detector 39 is focused on the position 43 of the film web 40.

The film web 40 runs in the machine direction 41 into the influencing element 30, passes to the first nip 31, the radiation pattern 42, continues to the second nip 32 and

leaves the influencing element 30 again.

The influencing element 30 is adapted to affect the web tension 44 at the position

43 of the film topography measurement with the film topography measurement system 33.

The defect image 50 of the film web 51 consists essentially of folds 53, 54, 55, 56,

57, 58, 59, 60, 62, 63, 66 extending substantially in the machine direction 52.

### LIST OF REFERENCE NUMBERS USED

1 blown film plant
2 extruder
3 blow head
4 reversing turn-out
5 treatment section
6 winder
7 foil bubble
8 flattening part
9 take-out roll
10 take-out roll
11 motor
12 reversing movement
13 double flat laid film web
14 film thickness profile measuring device
15 film thickness profile
16 reversing angle
17 data processing and evaluation unit
18 film topography measuring system
19 radiation source
20 detector
21 radiation pattern
22 position
23 film topography
24 setting variable
25 setting unit
30 influencing element
31 nip
32 nip
33 film topography measuring system
34 squeeze roll
35 squeeze roll
36 squeeze roll
37 squeeze roll
38 radiation source
39 detector
40 film web
41 machine direction
42 radiation pattern
43 position
44 web tension
50 error image
51 film web
52 machine direction
53 fold
54 fold
55 fold
56 fold
57 fold
58 fold
59 fold
60 fold
62 fold
63 fold
66 fold

1. Measuring device for measuring a two- or three-dimensional
film topography of a film web produced by a blown or cast film process with a radiation source, in particular a light source, a detector and a data processing and evaluation unit,
characterized in that
the radiation source and the detector have a different position,
the radiation source is configured for projecting a radiation pattern onto a designated running section of the film web, wherein the radiation pattern is preferred a line with in particular parallel light,
the detector is configured to detect the projected radiation pattern, especially to detect the projected line,
the detector is focused on the projected radiation pattern, in particular the projected line,
and the data processing and evaluation unit has programming, wherein the programming is configured for carrying out a triangulation method and/or a reflection method and/or a transmission method for determination of the film topography.

2. Measuring device according to claim 1, characterized in that the radiation source and the detector are positioned in a common housing. Page 4

3. Measuring device according to claim 1, characterized in that on
the designated running distance of the film web projected radiation patterns runs across to the machine direction across the entire width of the designated run of the
film web.

4. Measuring device according to claim 1, characterized
in that the onto the designated track of the film web projected
radiation pattern runs in the machine direction and has a length.

5. Measuring device according to claim 1, characterized in that the onto the designated running section of the film web projected radiation pattern runs at an angle diagonally across the designated running section of the film web.

6. Measuring device according to claim 5, characterized in that an adjusting device is provided for the angle.

7. Measuring device according to claim 1, characterized in that the device comprises a second detector, which is also connected to the data processing and evaluation unit and has a different position from the first detector and from the radiation source.

8. Plant for producing a film web, wherein the plant has an extruder for plasticizing a thermoplastic, a nozzle for the exit of the plastic, a deflection part and a winder,
characterized in that
the plant comprises a measuring device for inline measuring a two-dimensional o the three-dimensional film topography according to claim 1.

9. Plant according to claim 8, characterized in that
the plant comprises an—on a property and/or orientation of the film web acting -influencing element, wherein the influencing element may have an influencing device,
the measurement of the film topography is provided within the area of influence of the influencing element,
wherein the influencing element is configured to reduce—in particular completely—an error image of a second error,
in order to conclude to the dimension of the first error via a—due to the influencing process more increasing—error image of a first error compared with the error of the second error.

10. Plant for producing a film web according to claim 9, characterized in that the plant has a dancer roll for reducing tensile stress variations in the film web with the help of a regulation.

11. Plant according to claim 9, characterized in that the plant comprises—with respect to their machine direction before and/or after the film topography measurement—a nip in order to isolate the tensions in the film web with the nip before and/or after the film topography measurement.

12. Plant according to claim 9, characterized in that the plant comprises—in relation to its machine direction before and/or after the film topography measurement—a nip in order provide the tensions in the film web with the nip before and/or after the film topography measurement, specifically in the film web.

13. Plant according to claim 9, characterized in that the plant comprises—in relation to its machine direction before and/or after the film topography measurement—a nip in order adjust the tensile stresses in the film web with the nip before and/or after the film topography measurement, targeted to the ideal tension level.

14. Plant according to claim 9, characterized in that the film topography measurement is arranged downstream of a web centre control, which forces a central run in of the film web into the film topography measuring system.

15. Plant according to claim 9, characterized in that the film topography measurement is arranged before or after a deflection roller.

16. Plant according to claim 9, characterized in that the film topography measurement is arranged after a width spreader element.

17. Plant according to claim 9, characterized in that the film topography measurement is arranged after a seam station.

18. Plant according to claim 9, characterized in that the film topography measurement is arranged after a slit device.

19. Plant according to claim 9, characterized in that the film topography measurement is arranged after a tension measuring roll.

20. Method for inline pattern recognition of error images in a two-dimensional or three-dimensional film topography of a film web
which is produced in the blown film or cast film process,
characterized in that
a two-dimensional or three-dimensional film topography is determined as a measuring value, in particular with a measuring device according to claim 1,
the determined film topography is transmitted to a data processing and evaluation unit,
the data processing and evaluation unit classifies, systematically comparing, with the help of a film topography pattern recognition algorithm using a data base of predefined pattern properties, separates the error images contained in the pattern
and identifies the error images.

21. Method according to claim 20, characterized in that the predefined pattern properties include a number of error images defects across the width of the film web.

22. Method according to claim 20, characterized in that
the predefined pattern properties comprise a continuously or cyclically appearance of errors images.

23. Method according to claim 20, characterized in that
the predefined pattern characteristics comprise an increasing or decreasing manifestation of error images.

24. Method according to claim 20, characterized in that
the predefined pattern properties comprise a position of the error images on the film web.

25. Method according to claim 20,
characterized in that the predefined pattern properties comprise a helical course of the error images on the film web.

26. Method according to claim 20, characterized in that the predefined pattern properties comprise a rectilinear course of the error images
on the film web.

27. Method according to claim 20, characterized in that
the predefined pattern properties comprise a position of the error images on the film web in relation to the film web width.

28. Method according to claim 20, characterized in that the predefined pattern properties comprise a position of the error images on the film web in relation to the machine direction.

29. Method according to claim 20, characterized in that the predefined pattern properties comprise an orientation of the error images in relation
to an angle between 1° and 89° to the machine direction on the film web.

30. Method according to claim 20, characterized in that
the causes of the error images are analyzed.

31. Method according to claim 20, characterized in that
the pattern recognition algorithm is self-learning.

32. Method according to claim 20, characterized in that the pattern recognition algorithm learns by inputs of the machine operator.

33. Method according to claim 20, characterized in that
the data base of the pattern properties contains causes of the individual error images.

34. Method according to claim 20, characterized in that the data base of the pattern properties contains for the individual error images actions recommendations for stopping or reducing an error image by changing a setting variable in the manufacturing process to the film web.

35. Method according to claim 20, characterized in that the setting variable in the manufacturing process contains a recipe of the thermoplastic substance.

36. Method according to any claim 20, characterized in that the setting variable in the manufacturing process contains a nozzle cross-section for the exit of the plastic.

37. Method according to claim 20, characterized in that the setting variable in the manufacturing process includes the setting of a flattening part.

38. Method according to claim 20, characterized in that
the setting variable in the manufacturing process includes the setting of a lateral guide.

39. Method according to claim 20, characterized in that the setting variable in the manufacturing process includes the setting of a flatness position actuator.

40. Method according to claim 20, characterized in that the setting variables in the manufacturing process are divided into segmented control zones.

41. Method according to claim 20, characterized in that
for controlling the production process of a film web for reducing or preventing of error images an action recommendation from the data base of the pattern recognition is automatically used for controlling the manufacturing process of the film web.

42. Method according to claim 20, characterized in that for regulating the manufacturing process of a film web for preventing or reducing of error images an action recommendation from the data base of
the pattern recognition is automatically used for regulating the production process of the film web.

43. Use of the method according to claim 20 for the inline flatness determination of a—with a blow or cast film method produced—film web.

44. Plant for producing a film web, wherein the plant comprises an extruder for plasticizing a thermoplastic, a nozzle for the exit of the plastic, a deflection part and a winder,
characterized in that
the device comprises a measuring device according to, claim 1.

45. Plant according to the claim 44, characterized in that the plant for producing a film web comprises an influencing element according to claim 9.

46. Plant according to claim 44, characterized in that the
plant for producing a film web is configured in the form of a blown film or cast film.

47. (disturbance free error determination method) Method for inline determination of a first error, in particular flatness position error, of a—in the blown or cast film
produced—film web by means of a two- or multi-dimensional film topography measurement method,
wherein the film web has the first and a second error,
characterized in that
the method uses—on a property and/or orientation of the film web acting—an influence, in particular an influencing element
according to claim 9, in order to reduce—in particular
completely—an error image of the second error,
in order to conclude to the dimension of the first error, via a—due to the influencing process more increasing—error image of a first error compared with the error of the second error.

48. Method according to claim 47, characterized in that the tensile stress variations in the film web are reduced in the area of the film topography measurement with help of a regulation of the dancer roller.

49. Method according to claim 47, characterized in that the tensions in the film web are isolated with a nip before and/or after the film
topography measurement.

50. Method according to claim 47, characterized in that tensions in the film web are specifically generated in the film web with a nip before and/or after the film topography measurement.

51. Method according to claim 47, characterized in that
the tensile stresses in the film web are set targeted with a nip before and/or after the film topography measurement to the ideal tension level.

52. Method according to claim 47, characterized in that
the film topography measurement is performed after a web centre control, which forces a centrically run of the film web into the film topography measuring system.

53. Method according to claim 47, characterized in that the film topography measurement takes place before or after a deflection roller.

54. Method according to claim 47, characterized in that the film topography measurement is performed after a width spreader element (German: Breitstreckenelement).

55. Method according to claim 47, characterized in that the film topography measurement is carried out after a seam station.

56. Method according to claim 47, characterized in that the film topography measurement is performed after a slit device.

57. Method according to claim 47, characterized in that the film topography measurement takes place after a tension measuring roller.

58. (canceled)
